(19) United States
(12) Patent Application Publication
(10) Pub. No.: US 2024/0180777 A1
(43) Pub. Date: Jun. 6, 2024

(54) VIBRATION DEVICE

(71) Applicant: FOSTER ELECTRIC COMPANY, LIMITED, Tokyo (JP)

(72) Inventor: Masayuki Shibata, Akishima-shi, Tokyo (JP)

(21) Appl. No.: 18/284,860

(22) PCT Filed: Mar. 24, 2022
(86) PCT No.: PCT/JP2022/014168

§ 371 Date: Sep. 28, 2023

(30) Foreign Application Priority Data
Mar. 30, 2021 (JP) 2021-057388

(51) Int. Cl. A61H 23/02; H02K 33/18; H02P 25/034

(52) U.S. Cl. CPC A61H 23/0218; H02K 33/18; H02P 25/034; A61H 2201/123; A61H 2201/5002

(57) ABSTRACT

A vibration device includes a voice coil type actuator that applies vibration to a human body, and a control unit that outputs a control signal to the voice coil type actuator, the control signal being a signal which includes a waveform having a frequency band so as to vibrate the voice coil type actuator according to the control signal and having a peak frequency in the frequency band changing with time.

### TECHNICAL FIELD

The technology of the present disclosure relates to a vibration device.

### BACKGROUND ART

Conventionally, a massager using an actuator of an electromagnetic solenoid or a piezoelectric body has been known (Japanese Patent Application Laid-Open (JP-A) No. H11-332938 and Japanese Patent Application Laid-open (JP-A) No. 2000-5257).

For example, JP-A No. H11-332938 discloses a massage machine including a hitting member that hits a site to be treated, an electromagnetic solenoid including a plunger and a solenoid to which the hitting member is connected, and a drive control unit that controls energization to the solenoid, in which a striking force detection unit that detects a striking force by the hitting member, and the energization to the solenoid is controlled according to an output of the striking force detection unit.

In JP-A No. 2000-5257, a low-frequency AC voltage is applied to a polarized piezoelectric body to vibrate the piezoelectric body to massage an affected area.

### SUMMARY OF INVENTION

### Technical Problem

Here, an inexpensive vibration motor (for example, Eccentric Rotating Mass (ERM)) is generally used as a vibrating body for massage. This ERM has no or little frequency change over time.

Therefore, when vibration is applied to the human body by the ERM, sensation is paralyzed due to haptic receptor adaptability, and stimulation cannot be maintained. A motor with an excessive vibration force is often mounted for stronger stimulation.

In view of the above fact, an object of the technology of the present disclosure is to provide a vibration device capable of applying vibration to a human body so as to continue stimulation.

### Solution to Problem

According to one aspect of the present disclosure, there is provided a vibration device including: a vibrating body that applies vibration to a human body; and a control unit that outputs a control signal to the vibrating body so as to vibrate the vibrating body according to the control signal, the control signal being a signal that includes a waveform having a frequency band, and the control signal having a peak frequency in the frequency band that changes with time. Here, the vibration direction of the vibrating body includes, for example, a direction substantially parallel to a contact surface with the human body, a direction substantially perpendicular to the contact surface with the human body, and the like. The vibration direction is not limited to these directions.

### Advantageous Effects of Invention

According to one aspect of the present disclosure, by outputting a control signal in which a peak frequency of a frequency band changes with time to a vibrating body, it is possible to apply vibration to a human body so as to continue stimulation.

### BRIEF DESCRIPTION OF DRAWINGS

FIG. 1 is a cross-sectional view illustrating an overall configuration of a vibration device according to an embodiment of a technology of the present disclosure.

FIG. 2 is a block diagram illustrating a configuration of a control unit of the vibration device according to the embodiment of the technology of the disclosure.

FIG. 3A is a cross-sectional view illustrating a configuration of a voice coil type actuator of the vibration device according to the embodiment of the technology of the disclosure.

FIG. 3B is a schematic view illustrating a configuration of the voice coil type actuator of the vibration device according to the embodiment of the technology of the disclosure.

FIG. 4 is a diagram illustrating an example of a control signal that is a sine wave.

FIG. 5 is a diagram for explaining a method of continuously changing a peak frequency of the control signal.

FIG. 6 is a diagram illustrating an experimental result.

FIG. 7 is a diagram illustrating an acceleration measurement result in each control signal used in an experiment.

FIG. 8 is a diagram illustrating a relationship between a vibration frequency and a vibration acceleration in an eccentric motor and the voice coil type actuator.

### DESCRIPTION OF EMBODIMENTS

Hereinafter, embodiments of the technology of the present disclosure will be described in detail with reference to the drawings.

### <Configuration of Vibration Device According to Embodiment of Technology of Present Disclosure>

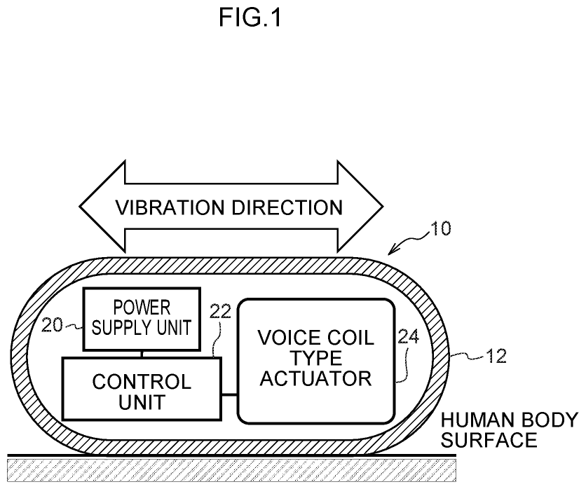

FIG. 1 is a cross-sectional view of a vibration device 10 according to an embodiment of a technology of the disclosure. As illustrated in FIG. 1, the vibration device 10 includes a power supply unit 20, a control unit 22, and a voice coil type actuator 24 in a housing 12.

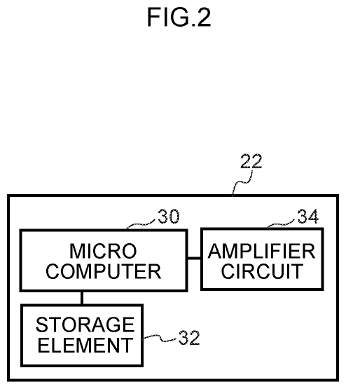

As illustrated in FIG. 2, the control unit 22 includes a microcomputer 30, a storage element 32, and an amplifier circuit 34.

The voice coil type actuator 24 vibrates in a vibration direction substantially parallel to a contact surface with a human body according to a control signal output from the control unit 22, thereby applying vibration to a human body surface and massaging the human body.

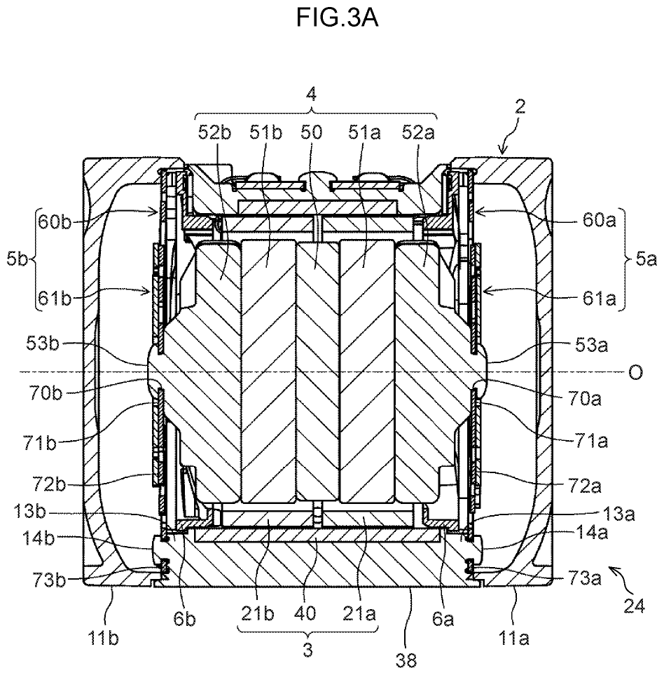

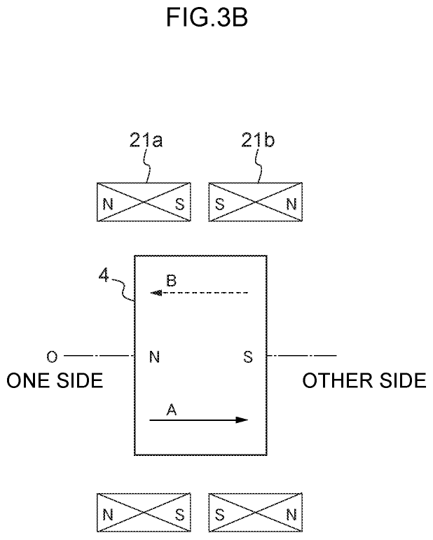

As illustrated in FIG. 3A, the voice coil type actuator 24 mainly includes a case 2 forming an outer shell, an electromagnetic drive unit 3, a movable element 4, a first support unit 5a, a second support unit 5b, a first inner guide 6a, and a second inner guide 6b. The electromagnetic drive unit 3 is provided in the case 2. The movable element 4 is configured to be vibratable by electromagnetic drive unit 3. The first support unit 5a and the second support unit 5b elastically support both ends of the movable element 4. The first inner guide 6a and the second inner guide 6b restrict the movement of the first support unit 5a and the second support unit 5b.

In the case 2, both open ends of a cylindrical case body are closed by a first cover case 11a and a second cover case 11b.

The electromagnetic drive unit 3 includes a yoke 40 that is disposed inside the case 2 and is made of a cylindrical soft magnetic material, and a first coil 21a and a second coil 21b that are attached to an inner surface of the yoke 40 in a state of being electrically insulated from the yoke 40.

The first coil 21a and the second coil 21b are wound along the inner surface of the yoke 40. Each of the first coil 21a and the second coil 21b can generate a magnetic field by energization from a terminal.

The movable element 4 is surrounded by first coil 21a and second coil 21b, and disposed so as to vibrate along vibration axis O. The movable element 4 includes a disk-shaped magnet 50, a disk-shaped first pole piece 51a and second pole piece 51b arranged so as to sandwich the magnet 50, and a first mass (weight) 52a and a second mass (weight) 52b arranged so as to sandwich the magnet 50, the first pole piece 51a, and the second pole piece 51b.

A magnetization direction of the magnet 50 is a direction of a vibration axis O. The first pole piece 51a and the second pole piece 51b are made of a soft magnetic material, and are attached to the magnet 50 by a magnetic attraction force of the magnet 50, an adhesive, and the like. The first mass 52a and the second mass 72b are made of a non-magnetic material, and are respectively attached to the first pole piece 51a and the second pole piece 51b with an adhesive or the like. Therefore, the magnet 50, the first pole piece 51a, the second pole piece 51b, the first mass 72a, and the second mass 52b constituting the movable element 4 are integrated. In the first mass 52a and the second mass 52b, contact surfaces with the first pole piece 51a and the second pole piece 51b are formed flat. The surface opposite to the contact surface is formed in a spiral shape in which the vibration axis O is set as the central axis and tip portions 53a and 53b on the central axis protrude most outward.

In the movable element 4 configured as described above, both end portions in the direction of the vibration axis O, that is, tip portions 53a and 53b of the first mass 52a and the second mass 52b are supported by the first support unit 5a and the second support unit 5b, respectively.

The first support unit 5a includes a first damper 60a (first leaf spring) and a first elastic member 61a provided on one surface of the first damper 60a.

In the first damper 60a, a support portion 71a having a hole 70a is formed in a central portion. The first damper 60a is connected to the movable element 4 through the hole 70a. Specifically, the tip portion 53a of the first mass 52a is inserted into the hole 70a, and the tip portion 53a is swaged by being crushed.

The first damper 60a has three arm portions 72a spirally extending from the support portion 71a to the outer periphery. The arm portions 72a are formed at equal intervals at a pitch of 120° around the vibration axis O. An outer peripheral end of each arm portion 72a is connected to an annular frame portion 73a along the inner surface of the case body. The frame portion 73a is connected by flange portions 13a protruding radially inward at three positions on the inner surface of the case body at a pitch of 120° around the vibration axis O.

The first damper 60a includes one or a plurality of metal leaf springs, and for example, in the present embodiment, a thin plate made of stainless steel (spring material) is used. The material of the first damper 60a is not limited to metal, and may be a composite material containing resin or fiber. A material that is resistant to fatigue and excellent in flexibility is desirable.

The first damper 60a configured as described above is elastically deformable within a predetermined range in an intersecting direction including the direction of the vibration axis O and the radial direction perpendicular to the vibration axis O. This predetermined range corresponds to an amplitude range of movable element 4 in a case where movable element 4 is normally used as voice coil type actuator 24. Therefore, the predetermined range is a range in which at least the first damper 60a does not come into contact with the case 2, and is a range that does not exceed a limit of elastic deformation of the first damper 60a.

The first elastic member 61a has a plate shape having an outer shape along a shape from the support portion 71a of the first damper 60a to a certain range of each arm portion 72a, and is fixed to one surface of the first damper 60a. Damping of the first damper 60a is performed by elastic deformation of the first elastic member 61a.

The second support unit 5b also has the same configuration as the first support unit 5a, and includes a second damper 60b (second leaf spring) and a second elastic member 61b. In the present embodiment, the second damper 60b and the first damper 60a have the same shape and the same material, and the second elastic member 61b and the first elastic member 61a have the same shape and the same material. The three arm portions 72b of the second damper 60b extend from the support portion 71b in which the hole 70b is formed to the annular frame portion 73b. The second damper 60b is connected to the movable element 4 by inserting the tip portion 53b of the second mass 52b into the hole 70b, crushing, and swaging. The second damper 60b is connected to the three flange portions 13b in which the annular frame portion 73b protrudes from the inner surface of the case body, by inserting the boss portion 14b of the flange portion 13b through the through hole formed in the frame portion 73b, crushing, and swaging. The spiral direction of each arm 72b of the second damper 60b is opposite to the spiral direction of each arm 72a of the first damper 60a. As a result, the movable element 4 receives the torque in the opposite direction from the first damper 60a and the second damper 60b at the time of vibration, and thus does not rotate about the vibration axis O even when the movable element 4 is displaced in the direction of the vibration axis O.

The first inner guide 6a is provided on one side in the direction of the vibration axis O of the voice coil type actuator 24 and on the other side (center side of the case 2) in the direction of the vibration axis O with respect to the first support unit 5a. The second inner guide 6b is provided on the other side in the direction of the vibration axis O of the voice coil type actuator 24, and is provided on one side (center side of the case 2) in the direction of the vibration axis O with respect to the second support unit 5b. That is, the first inner guide 6a and the second inner guide 6b are provided on the center side in the direction of the vibration axis O with respect to the first support unit 5a and the second support unit 5b in the case 2.

As illustrated in FIG. 3B, in the voice coil type actuator 24, in a state in which the first coil 21a and the second coil 21b are not energized, the movable element 4 supported by the first damper 60a and the second damper 60b is located at the centers of the first coil 21a and the second coil 21b.

When the movable element 4 is vibrated, alternating current is applied to the first coil 21a and the second coil 21b in directions in which magnetic fields of opposite polarities are alternately generated. That is, the same polarity is generated in adjacent portions of the first coil 21a and the second coil 21b.

For example, in the case of the polarity illustrated in FIG. 3B, thrust toward the other side (the right side in FIG. 3B) in the direction of the vibration axis O indicated by a solid arrow A is generated in the movable element 4, and when the current flowing to the first coil 21a and the second coil 21b is reversed, thrust toward one side (the left side in FIG. 3B) in the direction of the vibration axis O indicated by a dotted arrow B is generated in the movable element 4.

In this manner, when alternating current is applied to the first coil 21a and the second coil 21b, the movable element 4 vibrates along the vibration axis O while receiving biasing forces of the first damper 60a and the second damper 60b from both sides.

The storage element 32 stores data of a reference waveform of one cycle which is a sine wave for a plurality of frequencies.

The microcomputer 30 outputs a control signal to voice coil type actuator 24 so as to vibrate the voice coil type actuator 24 in a vibration direction substantially parallel to the contact surface with the human body by using data of reference waveforms of a plurality of frequencies stored in storage element 32. This control signal is a signal including a waveform having a frequency band, and is a control signal in which a peak frequency of the frequency band changes with time.

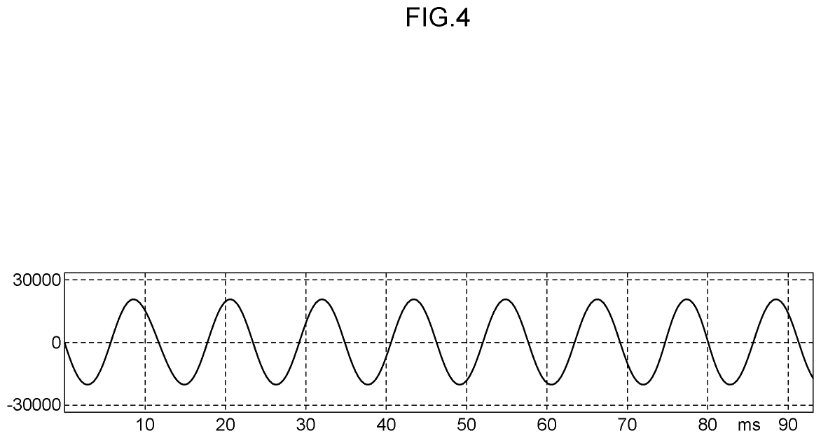

Specifically, the microcomputer 30 generates a sine wave as a reference waveform as a control signal for each of the plurality of frequencies (FIG. 4).

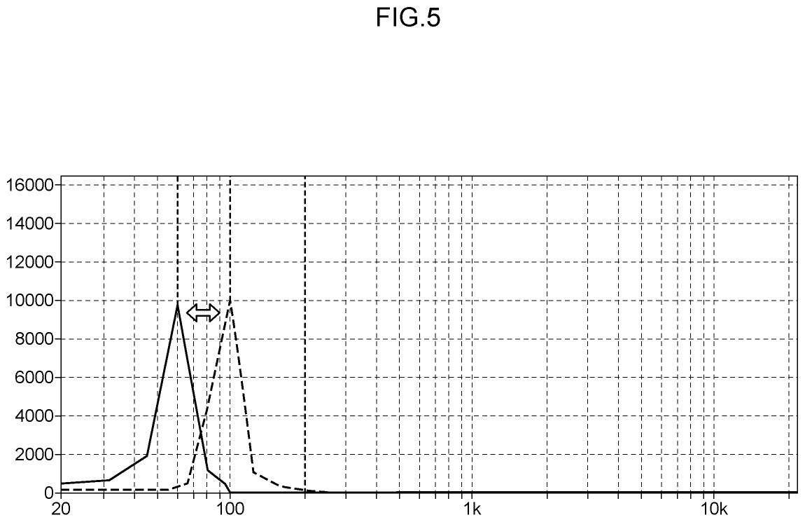

The microcomputer 30 repeatedly and continuously changes the peak frequency of the control signal within a range between a lower limit and an upper limit (FIG. 5). FIG. 5 illustrates an example in which the peak frequency of the control signal is continuously and repeatedly changed within the range of the lower limit and the upper limit, and the control signal having the low peak frequency and the control signal having the high peak frequency are alternately repeated.

The lower limit of the peak frequency is, for example, 15 Hz, and the upper limit of the peak frequency is, for example, 800 Hz. As a result, by alternately and continuously stimulating a frequency range including 15 to 100 Hz at which Meissner's corpuscles of a tactile receptor are susceptible to stimulation and 100 to 800 Hz at which Pacinian corpuscles are susceptible to stimulation, it is possible to apply vibration to the human body so as to continue stimulation.

### <Operation of Vibration Device According to Embodiment of Technology of Present Disclosure>

The vibration device 10 is built in a cavity portion of a massager (not illustrated). A user attaches the massager to the surface of the human body of a site to be massaged using a restraint member (not illustrated), and turns on the switch of the vibration device 10 by a remote operation such as a remote controller. In this case, the control unit 22 outputs the control signal to voice coil type actuator 24 so as to vibrate the voice coil type actuator 24 in the vibration direction substantially parallel to the contact surface with the human body. The control signal is a signal including a waveform having a frequency band, and is a control signal in which a peak frequency of the frequency band changes with time.

In this case, the voice coil type actuator 24 can apply vibration in which the peak frequency is continuously changed to the human body.

In this way, by changing the peak frequency and applying the vibration to the human body, the human body can continue to feel the vibration stimulation even when the vibration position is maintained at the same place.

### <Experimental Results>

A result of an experiment performed to evaluate an effect of applying vibration to a subject by the vibration device described in the above embodiment will be described.

After the subject was vibrated with an existing massager equipped with an eccentric motor, the subject was vibrated with thirteen types of control signals illustrated in the following table using the vibration device described in the above embodiment, and the strength of the vibration stimulation was evaluated by the subject's subjectivity.

TABLE 1

| No. | Signal waveform |
|---|---|
| 1 | Sine wave 60 Hz |
| 2 | Sine wave 100 Hz |
| 3 | Sine wave 160 Hz |
| 4 | Sine wave burst 60 Hz |
| 5 | Sine wave burst 100 Hz |
| 6 | Sine wave chirp 60 −> 100 Hz |
| 7 | Sine wave chirp 100 −> 60 Hz |
| 8 | Sine wave chirp 60 −> 100 Hz −> 60 Hz |
| 9 | Sine wave composite 60 + 64 Hz |
| 10 | Sine wave composite 60 + 85 Hz |
| 11 | Sine wave composite 115 + 140 Hz |
| 12 | Sine wave composite 60 + 60.5 Hz/Blowin |
| | noise/Sine wave burst 40 Hz |
| 13 | Sine wave frequency random 60 −> 100 Hz |

As illustrated in the above table, thirteen types of control signals include a control signal (No. 1) that is a sine wave of 60 Hz, a control signal (No. 2) that is a sine wave of 100 Hz, a control signal (No. 3) that is a sine wave of 160 Hz, a control signal (No. 4) that intermittently repeats a sine wave of 60 Hz, a control signal (No. 5) that intermittently repeats a sine wave of 100 Hz, a control signal (No. 6) that repeats continuously changing the frequency of a sine wave from 60 Hz to 100 Hz, a control signal (No. 7) that repeats continuously changing the frequency of a sine wave from 100 Hz to 60 Hz, a control signal (No. 8) that repeats continuously changing the frequency of a sine wave so as to reciprocate in a range between 60 Hz and 100 Hz, a control signal (No. 9) that is a composite wave obtained by combining sine waves of 60 Hz and 64 Hz, a control signal (No. 10) that is a composite wave obtained by combining sine waves of 60 Hz and 85 Hz, a control signal (No. 11) that is a composite wave obtained by combining sine waves of 115 Hz and 140 Hz, a control signal (No. 12) obtained by alternately repeating a control signal that is a composite wave obtained by combining sine waves of 60 Hz and 60.5 Hz, a control signal that is a Blowin noise, and a control signal that intermittently repeats a sine wave of 40 Hz, and a control signal (No. 13) which repeats random change of a frequency of a sine wave in a range of 60 Hz to 100 Hz. The control signals No. 1 to No. 3 are control signals that give simple vibration that is constant vibration. The control signals No. 4 to No. 13 are control signals that give pattern vibration in which vibration changes.

The subjects were 15 males aged 26 to 58 years. In order to block noise information, bodily sensation and evaluation were performed in a wearing state of an ear muff. The subject felt and evaluated in a state of gripping each of the existing massager and vibration device and touching the tip portion only with the index finger.

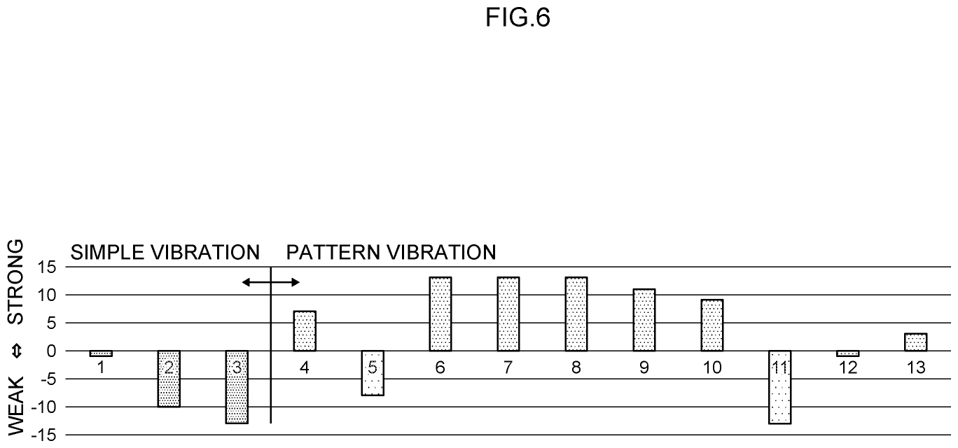

As a result, as illustrated in FIG. 6, a tendency that the stimulation was strong was observed in the control signal (No. 6 to No. 8) in which the frequency was continuously changed. As described above, it has been confirmed that low-frequency reproduction capability and responsiveness speed when the voice coil type actuator gives pattern vibration contribute to the stimulation improvement of massage. As compared with the control signal (No. 13) that randomly changes the frequency, it can be seen that the control signal (No. 6 to No. 8) that continuously changes the frequency can continue to feel the vibration stimulation.

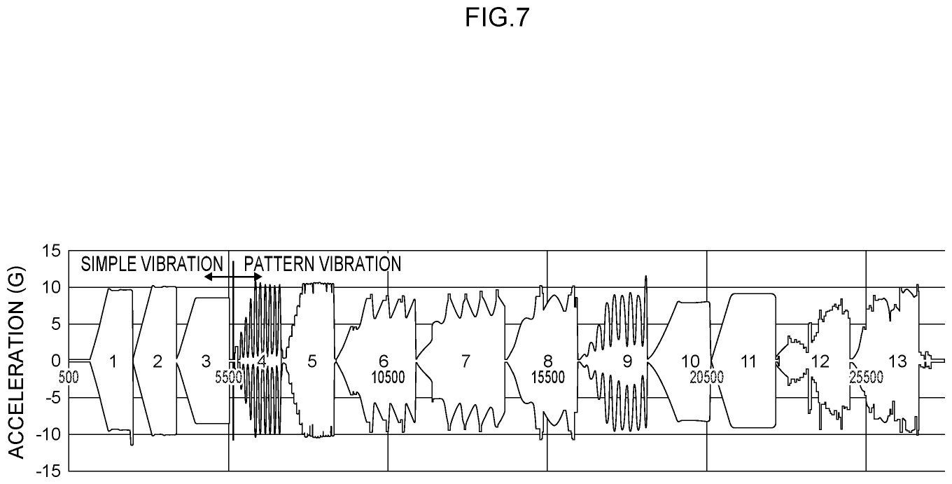

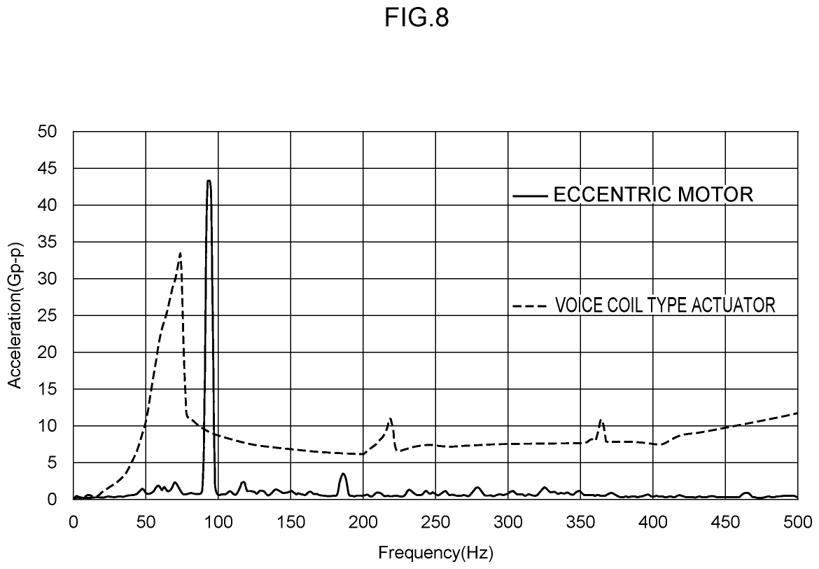

FIG. 7 illustrates acceleration measurement results of the control signals No. 1 to No. 13. FIG. 8 illustrates a relationship between a vibration frequency and a vibration acceleration in the eccentric motor and the voice coil type actuator. As described above, it can be seen that the voice coil type actuator has high low-frequency reproduction capability.

As described above, according to the vibration device according to the embodiment of the technology of the disclosure, by outputting the control signal in which the peak frequency of the frequency band changes with time to the voice coil type actuator, it is possible to apply vibration to the human body so as to continue stimulation. By continuously changing the peak frequency of the frequency band of the control signal, it is possible to apply vibration to the human body so as to continue stronger stimulation.

In the embodiment of the technology of the disclosure, since the voice coil type actuator is used, control in a wide frequency band is possible. Pacinian corpuscles are easily stimulated at a frequency of 100 Hz or more, and Meissner corpuscles are easily stimulated at a frequency of 100 Hz or less. Therefore, by repeatedly changing the peak frequency of the control signal in a frequency range including these frequency bands to give vibration, it is possible to give stimulation to different corpuscles of the human body and continue the stimulation.

In the voice coil type actuator, dampers (leaf springs) are provided in pairs. As a result, low-frequency vibration is easily generated, that is, low-frequency vibration is easily controlled.

The voice coil type actuator is configured as a cylinder type (column type). As a result, the voice coil type actuator has a shape suitable for low-frequency vibration.

The movable element of the voice coil type actuator is provided with a magnet, a yoke, and a weight. As a result, a suitable magnetic flux and weight can be obtained, and optimum vibration can be obtained.

According to the technology of the disclosure, the control unit outputs the control signal, which is the signal including the waveform having the frequency band so as to vibrate the vibrating body according to the control signal and in which the peak frequency in the frequency band changes with time, to the vibrating body.

In this manner, by outputting the control signal in which the peak frequency of the frequency band changes with time to the vibrating body, it is possible to apply vibration to the human body so as to continue stimulation.

In the control signal according to the technology disclosed above, the peak frequency may continuously change.

In the control signal according to the technology disclosed above, the peak frequency may repeatedly change within the predetermined range.

The vibrating body according to the technology of the above disclosure may be an actuator. The vibrating body may be a voice coil type actuator, a solenoid, or a linear actuator.

The vibrating body according to the technology of the above disclosure can apply vibration for massaging a human body.

The technology of the disclosure is not limited to the above-described embodiments, and various modifications and applications can be made without departing from the gist of the technology of the present disclosure.

For example, in the above-described embodiment, the case where the voice coil type actuator is used as the vibrating body has been described as an example, but the present invention is not limited thereto, and an actuator other than the voice coil type actuator may be used. For example, a solenoid, a linear actuator, or the like is included.

The technology of the disclosure can also be used in an electric beauty device using vibration. For example, a facial brush, a facial massager, and the like are included.

The disclosure of Japanese Patent Application No. 2021-057388 is incorporated herein by reference in its entirety.

All documents, patent applications, and technical standards described in this specification are incorporated herein by reference to the same extent as if each individual document, patent application, and technical standard were specifically and individually described to be incorporated by reference.

1. A vibration device comprising:
a vibrating body that applies vibration to a human body; and
a control unit that outputs a control signal to the vibrating body so as to vibrate the vibrating body according to the control signal, the control signal being a signal that includes a waveform having a frequency band, and the control signal having a peak frequency in the frequency band that changes with time.

2. The vibration device according to claim 1, wherein the peak frequency of the control signal continuously changes.

3. The vibration device according to claim 2, wherein the peak frequency of the control signal repeatedly changes within a predetermined range.

4. The vibration device according to claim 1, wherein the vibrating body is an actuator.

5. The vibration device according to claim 4, wherein the vibrating body is a voice coil type actuator, a solenoid, or a linear actuator.

6. The vibration device according to claim 1, wherein the vibrating body applies vibration for massaging the human body.
